(19) United States
(12) Patent Application Publication
(10) Pub. No.: US 2014/0106734 A1
(43) Pub. Date: Apr. 17, 2014

(54) Remote Invocation of Mobile Phone Functionality in an Automobile Environment

(71) Applicant: Beanco Technology L.L.C., Plano, TX (US)

(72) Inventor: Robert Tak-Kuen Lee, Allen, TX (US)

(73) Assignee: Beanco Technology L.L.C., Plano, TX (US)

(21) Appl. No.: 14/053,057

(22) Filed: Oct. 14, 2013

Related U.S. Application Data
(60) Provisional application No. 61/713,622, filed on Oct. 15, 2012.

(51) Int. Cl. H04W 8/24

(52) U.S. Cl. CPC H04W 8/24
USPC 455/419

(57) ABSTRACT

A remote invocation device useful in an automobile interior, by way of which advanced functions of a modern mobile telephone handset (i.e., smartphone) can be invoked and carried out via the in-car audio system. The remote invocation device includes wireless BLUETOOTH circuitry that is pairable with a smartphone via a profile different from that with which the smartphone is paired with the in-car audio system. The device has a button that, when pressed, causes a signal to be transmitted to the smartphone to invoke an advanced function, such as a virtual assistant app. Voice commands to, and audio responses by, the smartphone are communicated via the in-car audio system.

### CROSS-REFERENCE TO RELATED APPLICATIONS

This application claims priority, under 35 U.S.C. §119(e), of Provisional Application No. 61/713,622, filed Oct. 15, 2012, and incorporated herein by this reference.

### STATEMENT REGARDING FEDERALLY SPONSORED RESEARCH OR DEVELOPMENT

Not applicable.

### BACKGROUND OF THE INVENTION

This invention is in the field of mobile communications. Embodiments of this invention are more particularly directed to remote enabling of a mobile telephone handset in the environment of an automobile interior.

Modern mobile telephone handsets are typically able to be used in a “hands-free” manner, particularly in automobiles. As well known in the industry, hands-free operation of a mobile telephone allows the user of the mobile phone to place or answer a telephone call, and to carry on a telephone conversation (i.e., speak and listen), all without physically holding the handset. Automobile manufacturers have long been offering hands-free systems integrated into the vehicle, in which mobile phone calls are routed to the car's speakers and in-cabin microphone. This allows the driver to safely keep both hands on the steering wheel and eyes on the road to both dial a call and to carry on the telephone conversation; in addition, use of the vehicle's audio system provides excellent fidelity for the call.

The ever-increasing functionality of mobile phones, along with their continuing drop in cost for a given level of functionality, have increased usage of this communications technology. This increasing functionality, particularly in enabling email, text messaging, and Internet browsing and usage via the mobile phone handset has improved productivity and information consumption. But these functions are also tempting to use while driving, as reflected in the significant number of vehicular accidents caused by drivers being distracted by their mobile phone use.

Recently, many modern mobile phone handsets enable the use of voice commands to carry out these advanced functions. Conventional voice commands now allow the operator to initiate a phone call, read and compose text messages, obtain and receive turn-by-turn directions, retrieve sports scores, check the weather, and much more. These voice commands are thus compatible with safe operation of an automobile, especially as compared with use of a touchscreen to carry out the same operations while driving. However, the invocation of these functions in conventional mobile phone handsets still requires the pressing of a button on the phone (that button often referred to as the “home” button), in order to alert the phone that the user wishes to imminently provide a voice command.

Some modern vehicles now provide increased information functions, such as vehicle tracking, on-board navigation systems, and the like; those functions are implemented into the vehicles by way of software systems referred to as “telematics” software. In some conventional implementations, a fully featured mobile phone (often referred to as a smartphone) that is paired with an in-car hands-free system can be used in connection with those telematics functions. In that case, however, the built-in telematics software of the automobile will typically supersede the smartphone's functionality. As a result, depressing of the built-in call/talk button of the vehicle's hands-free system will only initiate the voice dialing feature of the vehicle, and cannot be used to invoke the advanced features of the smartphone (i.e., text messaging, email, Internet usage, etc.). In order to utilize those advanced smartphone features via voice commands, the driver must instead physically press the “home” button on the handset itself. Unfortunately, fumbling around to find the handset, hunt for the “home” button, and then push that button, all while driving, is dangerously distracting, especially considering that mobile phones are often not consistently kept in an accessible place in the automobile. As a result, invocation of voice control of a smartphone paired with an in-car hands-free system requires physical access to the handset while driving, which defeats the main advantage of in-car hands-free systems—keeping the driver's eyes on the road.

### BRIEF SUMMARY OF THE INVENTION

Embodiments of this invention provide a system and method of safely and consistently invoking voice command control of a mobile phone handset for purposes of text messaging, email, and Internet usage, while driving an automobile.

Embodiments of this invention provide such a system and method that enables use of the built-in audio system of the automobile for the invoked voice commands.

Embodiments of this invention provide such a system and method that is readily compatible with the BLUETOOTH hands-free transceiver systems of conventional automobiles.

Other objects and advantages of embodiments of this invention will be apparent to those of ordinary skill in the art having reference to the following specification together with its drawings.

An embodiment of the invention may be implemented by way of a remote invocation device placed in a fixed or consistent location in the interior of an automobile. The device can be paired for wireless communications with a mobile phone handset, for example of the “smartphone” type, via a profile different from that by way of which the handset is paired with the automobile hands-free system (i.e., which uses the built-in audio system). The device includes a button that invokes advanced features of the handset, for example as a remote press and hold of the handset “home” button to invoke voice command functionality at the handset. Voice commands and audio responses can then be communicated through the vehicle's speakers and in-cabin microphone.

### BRIEF DESCRIPTION OF THE SEVERAL VIEWS OF THE DRAWING

FIG. 1 is a perspective view, in schematic form, of the interior of an automobile illustrating an example of the deployment of embodiments of the invention.

FIGS. 2a and 2b are plan and elevation views, respectively, of a remote invocation device according to an embodiment of the invention.

FIG. 3 is an electrical diagram, in block form, illustrating the construction of a remote invocation device according to an embodiment of the invention.

FIG. 4 is an electrical diagram, in block form, illustrating communication between a remote invocation device and a handset, according to an embodiment of the invention.

FIG. 5 is a flow diagram illustrating the operation of the remote invocation device in combination with a handset, according to an embodiment of the invention.

### DETAILED DESCRIPTION OF THE INVENTION

This invention will be described in connection with its embodiments, namely as implemented into a remote invocation device and its operation in the context of an automobile interior, as it is contemplated that this invention is especially beneficial when used in such an application. However, it is also contemplated that the invoking of voice commands for execution by a mobile telephone handset, such as a smartphone, according to embodiments of this invention may be of benefit in many other uses and applications. Accordingly, it is to be understood that the following description is provided by way of example only, and is not intended to limit the true scope of this invention as claimed.

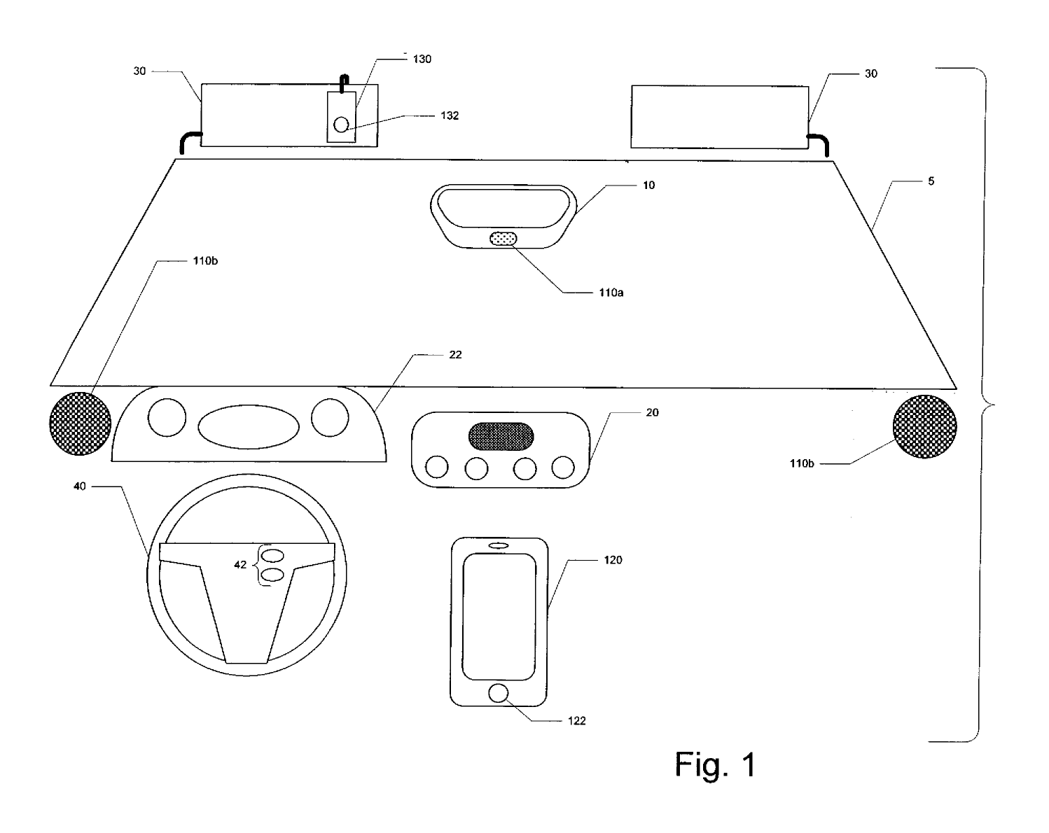

FIG. 1 illustrates an example of the context in which embodiments of the invention may be deployed. Specifically, FIG. 1 illustrates the interior of an automobile, looking in a direction toward windshield 5. As evident from FIG. 1, typical features in this automobile interior include rear-view mirror 10, instrument cluster 22, visors 30, and steering wheel 40. This particular instance of a car interior, also includes audio system 20 having hands-free communications capability. Audio system 20 includes the typical functions of modern automotive systems, including a radio receiver (including a satellite radio receiver if so equipped), compact disk player, digital audio playback capability via a jack or wireless connection, and in some cases a Global Positioning System (GPS) navigation system.

For purposes of its hands-free capability, audio system 20 is coupled to microphone 110a, mounted in the frame of rear-view mirror 10, and speakers 110b mounted throughout the interior, as suggested by FIG. 1. In its hands-free operation, as conventional in the art, audio system 20 is capable of responding to spoken commands sensed by microphone 110a, and of presenting audible responses via speakers 110b. As known in the art, a common application of such hands-free capability is communication with mobile telephone handset 120, by way of which the driver or a passenger of the automobile can place, carry out, and end telephone calls. In conventional hands-free capable automobiles, audio system 20 includes a wireless transceiver (not shown) and the corresponding appropriate “telematics” software to receive and respond to voice commands issued by the driver.

Typically, a phone call is initiated by the driver pressing one of buttons 42 on steering wheel 40, in response to which audio system 20 prompts the user for a voice command, such as “call” (followed by a previously stored “name tag”), or “dial” (followed by a telephone number). Upon receipt of the appropriate voice command, audio system 20 then communicates with handset 120 according to the applicable wireless protocol, such as the BLUETOOTH protocol, to cause handset 120 to place the mobile phone call. Audio between the driver and handset 120 is then routed to audio system 20, via the BLUETOOTH or other wireless connection. During the call, audio from the driver or other speaker will be received by microphone 110a and wirelessly communicated by audio system 20 to handset 120, and voice signals from the other party received by handset 120 will be wirelessly routed to audio system 20 for output at speakers 110b. The driver or other speaker may end the call by pressing another one of buttons 42 on steering wheel 40, or the call may simply end upon the other party hanging up, as conventional.

As known in the art, and as discussed above relative to the Background of the Invention, conventional communications between in-car audio system 20 under the BLUETOOTH standard and protocol are carried out via a “hands-free profile” according to the standard. As known in the art, a “profile” under the BLUETOOTH standard refers to a particular “specification” in which selected features of the core BLUETOOTH standard are enabled or used for a wireless pairing that is made under that specific profile. For example, as discussed above, the hands-free BLUETOOTH profile, known in the art as “HFP”, allows the hands-free kit of an automobile to communicate with mobile telephone handsets in that automobile. The hands-free profile specifies the particular modulation and quantization to be applied, and the specific functions of the handset that are to be made available to the hands-free kit. The functions implemented by the hands-free profile include accept/reject an incoming call, place a call, terminate a call, audio connection transfer during a call, connection management, phone status information, audio connection handling, and various optional features such as call waiting, last number redial, and the like. Additional detail regarding the features and functions of the BLUETOOTH hands-free profile is provided by the Hands-Free Profile (HFP) 1.5 specification, prepared by the Car Working Group of the Bluetooth Special Interest Group (Nov. 25, 2005), incorporated herein by reference.

In contrast, other BLUETOOTH profiles enable other functions and signals to be communicated between paired devices. One example of such a profile is the “human interface profile”, or “HID” profile, described in detail in the Human Interface Device Profile (HID) 1.1 specification prepared by the Human Interface Device Working Group of the Bluetooth Special Interest Group (Feb. 21, 2012), incorporated herein by reference. As known in the art, the HID profile is directed to input and output devices such as keyboards, mice, trackballs, and the like. According to that specification, the HID Profile provides the function of “input reports”, in which information is communicated from a BLUETOOTH HID device to its host, with the contents of that transmitted information corresponding to a user input as applied to the HID device (e.g., a change in position of a computer mouse, or the pressing of a key on a keyboard).

As discussed above in the Background of the Invention, modern smartphones implement many advanced features beyond merely the placing and conducting of a phone call. These advanced features include the sending and receiving of email, the sending and receiving of text messages, Internet access, and the like. In addition, some modern high-performance mobile telephone handsets include the ability to interpret and respond to free-form voice commands, by determining the desired handset function to be performed and by invoking that handset function to carry out the voice command. For the example of the IPHONE smartphone handset available from Apple Inc., the user can activate voice commands by pressing and holding the “home” button on the handset, in response to which the handset will prompt the user to provide a voice command. Modern mobile telephone handsets operating under other operating systems, such as the ANDROID operating system available from Google Inc., and the WINDOWS MOBILE family of operating systems available from Microsoft Corporation, may include a “home” button to invoke voice command control as described above, or more typically may include a “soft key” (e.g., a microphone button on the touchscreen) that invokes execution of a method enabling voice command control of the handset. In any case, the voice commands that the user may provide in this situation may be a predefined command in the “vocabulary” of the handset (which may be defined by the manufacturer, in some cases including user-defined voice commands that are “learned” by the handset by way of a utility).

Some modern smartphone handsets include an application, or “app”, that is capable of responding to free-form, or natural language, voice commands, by invoking other apps or functions of the handset accordingly. For example, newer versions of the IPHONE handset include the SIRI virtual assistant app, which interprets and responds to free-form voice or text commands. In these newer IPHONE handsets, the SIRI virtual assistant app is invoked by a press-and-hold of the home button. For example, once the SIRI virtual assistant app is invoked, the user may provide the voice command “send a text message to Jane Doe” to which the SIRI virtual assistant app will respond by initiating the messaging app on the handset, and starting a new text message to Jane Doe. Another example of such a command may be “give me directions home”, to which the SIRI virtual assistant app will respond by initiating a “maps” app on the handset, invoking the GPS functionality to determine the current location of the handset, and obtaining directions from that current location to an address previously registered on the handset as “Home”, which can then be communicated to the user in a “turn-by-turn” manner as the handset travels. Other functions available via the SIRI virtual assistant app include carrying out Internet searches, composing email messages, reading text and email messages, and the like. Similar virtual assistant applications are available for some newer smartphone handsets operating under the ANDROID and WINDOWS MOBILE operating systems.

It has been discovered, in connection with this invention, that the invoking of voice commands by the pressing and holding of the home button on the handset can be cumbersome and distracting in the vehicle environment when sought to be performed by a driver. The driver must locate the handset, the location of which can be in any one of a number of places such as a coat pocket, purse, briefcase, glove compartment, and the like, orient the handset to find the home button, and then press the home button until the screen of the handset indicates that voice commands can now be received. As mentioned above, the hands-free kit cannot be used invoke voice command functionality, because the hands-free vehicle kit is typically paired with the mobile telephone handset via the hands-free BLUETOOTH profile, in which pressing and holding of the home button is not an available function.

According to embodiments of this invention, remote invocation device 130 is deployed within the interior of the automobile. As will be described in further detail below, remote invocation device 130 is capable of wirelessly communicating with handset 120, paired under a profile other than the hands-free profile by way of which handset 120 is paired with audio system 20, specifically to issue a command corresponding to a “press-and-hold” of its home button 122, and to thus invoke voice command functionality. In this regard, remote invocation device 130 includes button switch 132, which the driver or another user may press in place of pressing and holding the home button 122 at handset 120. In response to the pressing of button switch 132, remote invocation device 130 issues a wireless signal to handset 120, in response to which handset 120 will execute a sequence of operations including the invocation of voice command functionality, as will also be described in detail below.

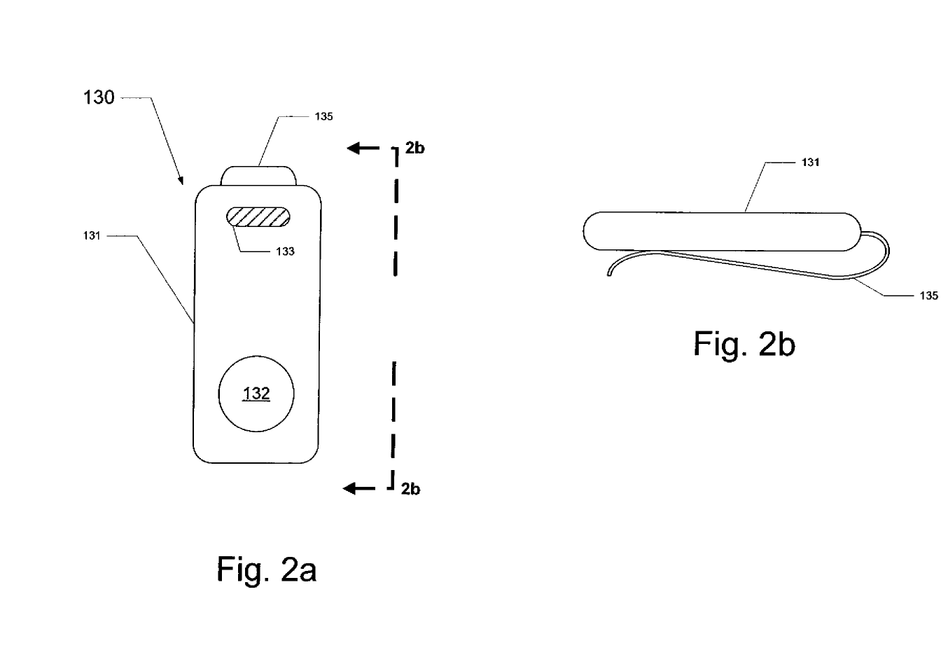

FIGS. 2a and 2b illustrate the construction of an example of remote invocation device 130 according to an embodiment of the invention. In this embodiment of the invention, remote invocation device 130 has housing 131, typically constructed of plastic, having a top surface at which button switch 132 is disposed. In this example, indicator 133, for example in the form of a light-emitting diode (LED) underlying a window in housing 131, is provided. Typically, it is contemplated that indicator 133 will illuminate during such time as the user presses button switch 132, thus providing visual feedback that remote invocation device 130 is powered-up (e.g., has sufficient battery power), and is functioning properly to sense the actuation of button switch 132.

Remote invocation device 130 according to this embodiment of the invention includes the appropriate hardware for being mounted, affixed, or otherwise attached to the interior of the automobile. In the embodiment of the invention shown in FIGS. 2a and 2b, this attachment hardware is in the form of visor clip 135, in the form of a relatively stiff metal strap molded into or otherwise attached to housing 131, and bending under housing 131 with some spring tension, in the conventional way for visor clips. Alternatively, housing 131 may be constructed to have one side of a VELCRO hook-and-loop fastener system, to allow attachment and removal of remote invocation device 130 from the dashboard or another location of the vehicle interior at which the other side of the fastener system adheres. Remote invocation device 130 may be attached to a location in the interior of the automobile by any one of a number of other techniques, as conventional in the art. In any case, attachment of remote invocation device 130 to a particular location of the vehicle interior is contemplated to provide important benefits in operation, as will be described below. It is of course contemplated that various alternatives and variations to the particular construction of housing 131 and arrangement of remote invocation device 130 may alternatively be implemented, as will be apparent to those skilled in the art having reference to this specification, such alternatives and variations being within the scope of this invention as claimed.

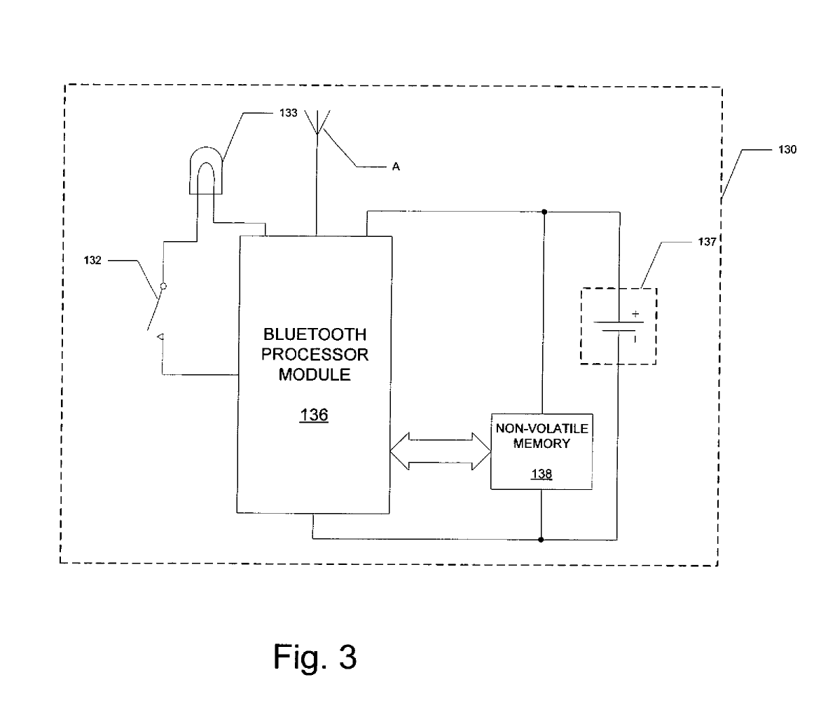

An example of the electrical architecture of remote invocation device 130 according to an embodiment of the invention will now be described, with reference to FIG. 3. As shown in FIG. 3, remote invocation device 130 includes processor module 136, which in general corresponds to an integrated circuit including a baseband controller and high-frequency radio frequency transceiver, and having the computational capacity and capability for “pairing” (i.e., establishing a wireless communication connection or link) with another wireless device, such as handset 120, under the BLUETOOTH standard and protocol managed by the Bluetooth Special Interest Group, as familiar to those skilled in the art. Examples of integrated circuits suitable for use as processor module 136 in embodiments of this invention include the CC2560 transceiver module available from Texas Instruments Incorporated, and the RN41 BLUETOOTH module available from Roving Networks. The transceiver function of processor module 136 is coupled to antenna A, by way of which the BLUETOOTH-compatible wireless signals are transmitted. In some implementations, antenna A may be “built-in” to the same integrated circuit or package as processor module 136, as known in the art.

Remote invocation device 130 also includes non-volatile memory 138, which in embodiments of the invention stores program instructions for controlling the operation of processor circuitry within processor module 136. Non-volatile memory 138 may be realized by any one of a number of technologies, including electrically erasable read-only memory (EEPROM), flash memory, mask-programmable ROM, and the like. It is contemplated that non-volatile memory 138 may be realized in the same integrated circuit as processor module 136, or alternatively may be realized as a separate integrated circuit as suggested by FIG. 3. Each of processor module 136 and non-volatile memory 138 are powered by battery 137, which is also deployed within remote invocation device 130.

In this embodiment of the invention, button switch 132 and indicator 133, in the form of an LED, are also coupled to processor module 136. Button switch 132 is constituted by an electrical switch that is actuated by the user pressing an external button, or membrane, at the surface of housing 131 as shown in FIG. 2a. In this example, button switch 132 is actuated by pressure applied by the user, specifically by closing when button switch 132 is pressed. Alternatively, button switch 132 may open upon pressing by the user, or it may be implemented in some manner that is indirectly actuated (closed or opened) in response to the user pressing a button or a particular location of housing 131, as known in the art. Indicator 133 is shown as in series with button switch 132, such that actuation of button switch 132 will close its circuit, allowing indicator 133 to light up so long as remote invocation device 130 is powered by battery 137 in combination with button switch 132 being closed. It is, of course, contemplated that indicator 133 may be indirectly coupled or responsive to button switch 132; for example, processor module 136 may illuminate indicator 133 via other hardware or via software control, in response to actuation of button switch 132 by the user.

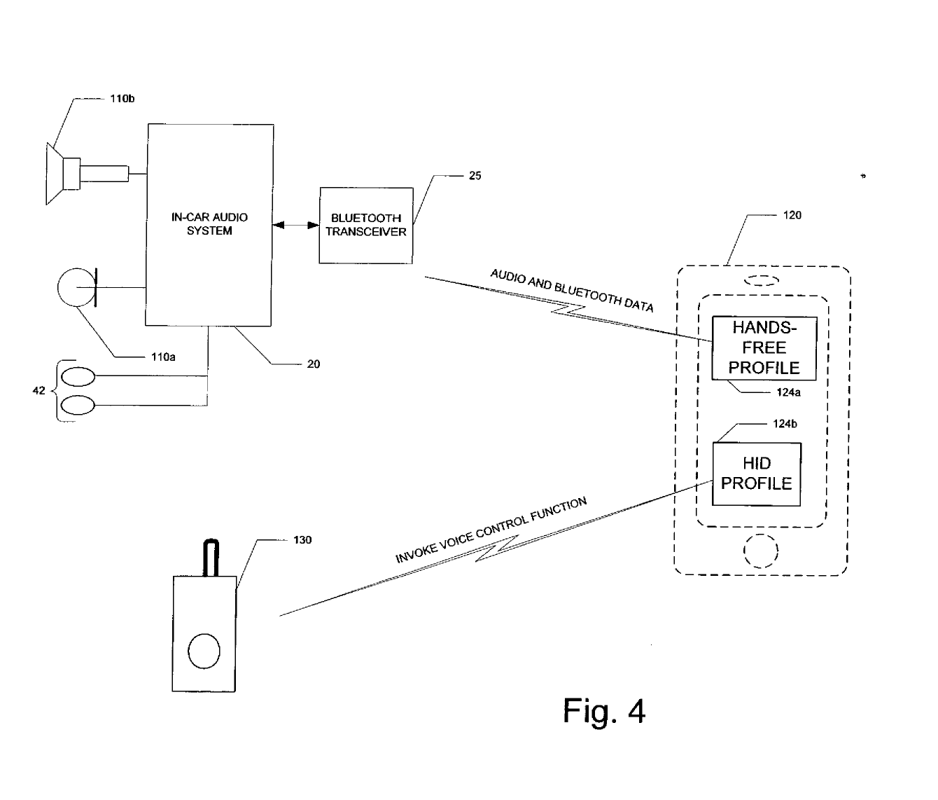

Referring now to FIG. 4, the operation of mobile invocation device 130 with handset 120 in the automotive environment of FIG. 1, according to embodiments of the invention, will now be described. According to embodiments of the invention, handset 120 is paired with remote invocation device 130 using a profile different than the profile with which handset 120 is paired with audio system 20.

As shown in FIG. 4, handset 120 is wirelessly connected to (i.e., paired with) audio system 20, specifically its BLUETOOTH transceiver 25, via BLUETOOTH hands-free profile 124a. According to embodiments of the invention, remote invocation device 130 is wirelessly connected to (i.e., paired with) handset 120 via a BLUETOOTH profile other than the hands-free profile. Examples of such alternative profiles, by way of which remote invocation device 130 may be paired with handset 120, include human interface device (HID) profile 124b, the AVRCP (Audio/Video Remote Control Profile), the SPP (Serial Port Profile), and the like. The use of a different profile by way of which remote invocation device 130 is paired with handset 120, as compared with the HFP profile by way of which audio system 20 is paired with handset 120, both avoids ambiguity at handset 120 regarding which device it is communicating with, and also allows remote invocation device 130 to use commands and functions that are not available under the hands-free profile. In particular, the use of this different profile (e.g., the HID, AVRCP, SPP, and other profiles) enables remote invocation device 130 to communicate a signal that handset 120 interprets as a press-and-hold of its home button 122.

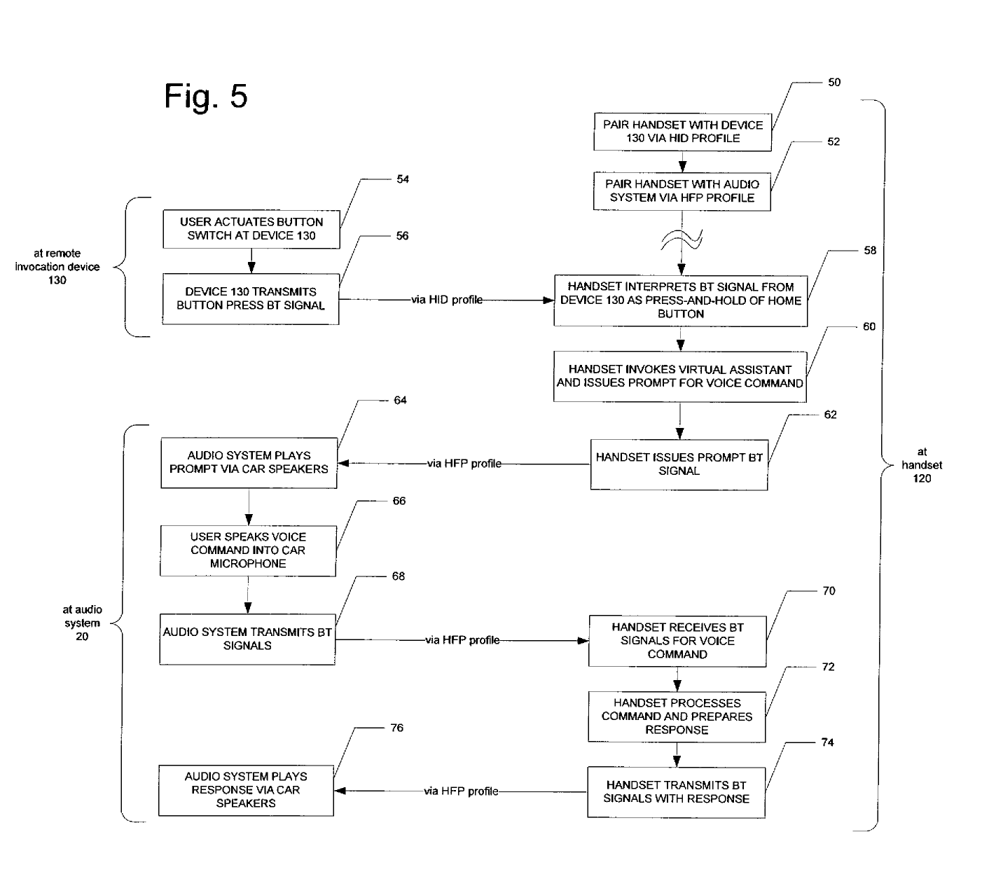

Referring now to FIG. 5, the operation of the system of FIG. 4 according to an embodiment of the invention will now be described in detail. This operational process begins with the pairing of handset 120 with remote invocation device 130 in process 50, and the pairing of handset 120 with in-car audio system 20 in process 52. Processes 50, 52, may be performed in any order relative to one another, and may be performed manually (e.g., pairing handset 120 by way of its settings or a utility), or automatically (e.g., handset 120 automatically connecting itself as it or the vehicle is turned on, having previously been paired with either or both of audio system 20 and remote invocation device 130), each of which is conventional in the art. In any case, pairing processes 50, 52 are performed using different BLUETOOTH profiles from one another. As mentioned above, audio system 20 is typically paired via the hands-free profile in process 52; as such, remote invocation device 130 is paired using a different profile, for example using the human interface device (HID) profile, as mentioned above.

Once both audio system 20 and remote invocation device are paired, the system is ready for operation as desired by the driver or another user. At such time as a user wishes to use voice commands to carry out one of the advanced functions of handset 120 (i.e., beyond placing or receiving a telephone call), the user performs process 54 by actuating button switch 132 at remote invocation device 130. Process 54 is contemplated to be typically performed by a simple press and release of button switch 132; alternatively, since button switch 132 is intended to mimic home button 122 at handset 120, actuation process 54 may involve a press-and-hold of button switch 132 (corresponding to the press-and-hold of home button 122 to invoke voice commands or the virtual assistant app). In process 56, remote activation device 130 transmits a BLUETOOTH signal corresponding to the event of button switch 132 being actuated. This BLUETOOTH signal is transmitted by remote activation device 130 according to the specifications of the profile with which it has been paired in process 50, for example the HID profile as discussed above.

In process 58, handset 120 receives the signal transmitted by remote activation device 130 in process 56, and interprets this signal as a press-and-hold of home button 122. Such interpretation of received signals by handset 120, according to the paired profile, is executed by processor circuitry in handset 120, as known in the art. In process 60 of this example, handset 120 invokes the virtual assistant app (e.g., the SIRI app for IPHONE handsets) in response to the interpretation of the received signal as a press-and-hold of home button 122, and in its execution of that virtual assistant app, issues a prompt to the user for a voice command. Because handset 120 is paired with audio system 20 under the hands-free (HFP) profile as a result of process 52, handset 120 issues a BLUETOOTH signal to audio system 20, via the HFP profile, in process 62.

In process 64, transceiver 25 of audio system 20 receives the BLUETOOTH signal indicating the voice command prompt issued by handset 120, and in response to that received signal, audio system 20 plays an audio prompt message via its speakers 110b (FIG. 1). This prompt message may be a simple tone (e.g., a tone associated with the virtual assistant app), or alternatively may be a “spoken” message asking for a voice command. Assuming that the user hears the prompt for a voice command, the user then speaks the desired voice command into microphone 110a in process 66, in response to which audio system 20 transmits BLUETOOTH signals corresponding to that voice command, via the HFP profile, in process 68. In the case of handset 120 being a smartphone that has invoked a virtual assistant app in process 60, this voice command may be a natural language, or free-form, voice command. If the application invoked at handset 120 in process 60 is a simpler voice command control function, this voice command will correspond to a command in the vocabulary of that control function in order for the operation to be successful.

In process 70, handset 120 receives the signals indicating the voice command, and in process 72, processing circuitry in handset 120 processes that command and prepares its response. According to embodiments of the invention, the processing carried out by handset 120 in process 72 may vary widely, depending on the capability of handset 120 and its virtual assistant app or voice command control function, as the case may be. Examples of the types of functions that may be performed by handset 120 in process 72 include the following:
composing and sending a text message (e.g., a Short Messaging Service (SMS) message) to one or more selected recipients, both the message and the recipients specified by the voice command
composing and sending an email to one or more selected recipients, both the email contents and the recipients specified by the voice command
text-to-audio conversion and audio output of received emails or text messages
obtaining turn-by-turn directions to a location (address, or previously stored location associated with a “name tag”) from the current GPS location of the vehicle
performing an Internet search
   Other functions and operations that may be called by way of voice command may also be performed in process 72. In the case of a virtual assistant app being invoked in process 60, that virtual assistant app will typically interpret the natural language voice command, and invoke the appropriate application at handset 120 for that voice command for execution in process 72.

In process 74, the appropriate output generated by handset 120 in response to the received voice command is transmitted by handset 120 as BLUETOOTH signals, via the HFP profile. Of course, the nature, length, and timing of this output will depend on the particular function executed in process 72 in response to the voice command. Some applications will provide merely an acknowledgement (e.g., “message sent”), others will provide lengthier output (e.g., reading a received email or text message), while others will provide audio output over time (e.g., in the case of turn-by-turn directions). These signals are received by audio system 20 via the BLUETOOTH HFP profile, and played over speakers 110b in process 76.

Processes 54 through 76 may, of course, be repeated to such an extent as desired by the driver or other user of the system, so long as handset 120 remains paired with audio system 20 and remote invocation device 130.

It is contemplated that alternative uses and implementations of remote invocation device 130 in combination with mobile telephone handset 120 and audio system 20 will also be apparent to one skilled in the art having reference to this specification. As such, the process flow of FIG. 5 is presented by way of example only.

Embodiments of the invention provide one or more important benefits and advantages in the use and operation of advanced features of smartphones and other devices in the automotive context. One such benefit and advantage is improved road safety by limiting, if not eliminating, a source of driver distraction. According to embodiments of the invention, a remote invocation device can be mounted securely to a fixed or consistent location inside the vehicle, within easy reach and access of the driver, while the mobile telephone handset can be physically stored anywhere in the interior of the vehicle, so long as it remains within the radio frequency range of the BLUETOOTH signals. The physical location of the handset in the vehicle is no longer relevant in the invocation of these advanced functions. For example, the handset can be located in the driver's pocket, briefcase, purse, glove compartment, door pocket, or any other location in the interior of the vehicle; in fact, the driver need not know precisely where the handset is located in order to use its advanced functions, according to embodiments of the invention. Rather, the driver need only know where the remote invocation device is located. It is contemplated that, in most cases, the driver will not even need to look at the remote invocation device in order to actuate its button switch and invoke the voice command capability of the handset. As a result, the driver can carry out these advanced functions while remaining safely focused on the road and his operation of the vehicle.

Another important benefit made available by embodiments of the invention is the use of the in-car audio system (including its microphone and speakers) for receiving voice commands and presenting the audio response of the mobile telephone handset to those voice commands. As well-known by modern drivers and passengers, the audio quality of the in-car audio system of modern cars is very good, and thus the fidelity of the commands and responses for these advanced functions as provided according to embodiments of the invention will similarly be very good. In addition, use of the in-car audio system for voice command input and response output allows the radio, CD player, MP3 player, or other currently playing function to be muted during such times as the prompting for voice commands, and the audio output of responses by the handset to those commands. Separate microphone and speaker systems for carrying out this function would not enable such muting, resulting in interference (voice commands received by the handset being the sum of the actual command and the current output of the in-car audio system), and drowning out of the spoken response to those commands by the ongoing audio system output. While the driver could manually mute the audio system during voice command control, such muting requires the attention of the driver, and additionally could be ineffective in the case of receiving turn-by-turn directions, as those directions will occur over time as needed, according to the then-current GPS location of the vehicle.

Another benefit made available by some embodiments of the invention is the compatibility of a remote activation device with existing vehicle audio systems and mobile telephone handsets. Most modern mobile telephone handsets are capable of pairing with a wide range of BLUETOOTH-enabled devices, and thus are operable in this regard via a number of BLUETOOTH profiles. As such, pairing of a mobile phone with a remote invocation device according to embodiments of this invention is expected to be well within the capability of existing handsets, and does not require any change in mobile phone software to carry out. In addition, the deployment of a remote invocation device in an existing vehicle does not require any change to the vehicle itself, or to its audio system, so long as that vehicle already includes a hands-free kit that is pairable with a smartphone handset. Accordingly, installation and use of a remote invocation device according to embodiments of this invention are contemplated to be simple and straightforward, as no modification of existing systems, hardware, and software is believed necessary.

While this invention has been described according to its embodiments, it is of course contemplated that modifications of, and alternatives to, these embodiments, such modifications and alternatives obtaining the advantages and benefits of this invention, will be apparent to those of ordinary skill in the art having reference to this specification and its drawings. It is contemplated that such modifications and alternatives are within the scope of this invention as subsequently claimed herein.

What is claimed is:

1. A method of operating a mobile telephone handset in an automobile, comprising:
pairing a wireless remote invocation device mounted in the interior of the automobile with the handset via a first profile;
pairing the handset with an audio system in the automobile via a second profile;
responsive to a user pressing a button on the wireless device, wirelessly transmitting a button press signal to the handset via the first profile;
responsive to receiving the button press signal at the handset, enabling the handset to receive voice commands;
then wirelessly transmitting signals corresponding to a voice command received from a microphone in the interior of the automobile to the handset via the second profile; and
responsive to receiving the transmitted signals at the handset, operating the handset to execute program instructions corresponding to the voice command.

2. The method of claim 1, wherein the transmitting steps each comprise transmitting wireless signals under the BLUETOOTH protocol.

3. The method of claim 2, wherein the second profile corresponds to a BLUETOOTH hands-free profile.

4. The method of claim 3, wherein the first profile corresponds to a BLUETOOTH human interface device profile.

5. The method of claim 1, wherein the button press signal corresponds to a command, at the handset, equivalent to the pressing-and-holding of a home button on the handset.

6. The method of claim 1, wherein the button press signal corresponds to a command, at the handset, equivalent to the pressing of a soft key at the handset.

7. The method of claim 1, further comprising:
responsive to the button press signal, transmitting signals corresponding to a voice command prompt from the handset to the audio system via the second profile.

8. The method of claim 1, wherein the step of operating the handset to execute program instructions comprises:
composing an message corresponding to the received signals; and
sending the message via a communications facility.

9. The method of claim 1, wherein the step of operating the handset to execute program instructions comprises:
transmitting signals to the audio system, via the second profile, the signals corresponding to an audio conversion of an email message received by the handset over a communications facility.

10. The method of claim 1, wherein the step of operating the handset to execute program instructions comprises:
invoking a virtual assistant application.

11. The method of claim 10, wherein the step of operating the handset to execute program instructions further comprises:
obtaining directions to the desired destination address from a current location of the automobile via communications over a communications facility;
transmitting signals to the audio system, via the second profile, the signals corresponding to an audio translation of the directions to the desired destination address.

12. A remote invocation device for wirelessly communicating with a mobile telephone handset, comprising:
a housing;
a switch disposed at a surface of the housing;
an antenna;
processor circuitry coupled to the switch and to the antenna;
program memory coupled to the processor circuitry, the program memory storing program instructions that, when executed by the processor circuitry, cause the processor circuitry to perform a plurality of operations comprising:
pairing the device with the handset according to a selected profile; and
responsive to actuation of the switch, wirelessly transmitting a corresponding signal to the handset according to the selected profile.

13. The device of claim 12, wherein the transmitting operation comprises transmitting wireless signals under the BLUETOOTH protocol.

14. The device of claim 12, wherein the profile corresponds to a BLUETOOTH human interface device profile.

15. The device of claim 12, wherein the transmitted signal corresponds to a command, at the handset, equivalent to the pressing and holding of a home button on the handset.

16. The device of claim 12, wherein the transmitted signal corresponds to a command, at the handset, equivalent to the pressing of a soft key at the handset.

17. The device of claim 12, wherein the switch is the only switch disposed at the surface of the housing.

18. The device of claim 12, further comprising:
an indicator for indicating actuation of the switch.

19. The device of claim 12, further comprising:
means for attaching the housing to a location in the interior of an automobile.

20. The device of claim 19, wherein the attaching means comprises:
a visor clip.
